(19) United States
(12) Patent Application Publication
(10) Pub. No.: US 2007/0025098 A1
(43) Pub. Date: Feb. 1, 2007

(54) Backlight assembly and liquid crystal display having the same

(75) Inventors: Joong-hyun Kim, Suwon-si (KR); Seong-yong Hwang, Seongnam-si (KR); In-sun Hwang, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/472,611

(22) Filed: Jun. 22, 2006

(30) Foreign Application Priority Data
Jul. 29, 2005 (KR) 2005-69841

(51) Int. Cl. G09F 13/04

(52) U.S. Cl. 362/97

(57) ABSTRACT

A backlight assembly includes a light guiding plate having a plurality of color converters formed on at least one surface thereof, and a light source part for supplying light to the light guiding plate.

### CROSS-REFERENCE TO RELATED APPLICATION

This application claims priority from Korean Patent Application No. 2005-0069841, filed on Jul. 29, 2005, the disclosure of which is incorporated by reference in its entirety herein.

### BACKGROUND OF INVENTION

1. Technical Field

The present disclosure relates to a backlight assembly and a liquid crystal display device having the same, and more particularly, to a backlight assembly having a color converter formed on a reflective surface of a light guide plate, and a liquid crystal display having the same.

1. Discussion of the Related Art

A flat display device such as, for example, a liquid crystal display (LCD), a plasma display panel (PDP), and an organic light emitting diode (OLED) is widely used.

The LCD comprises a thin film transistor substrate, a color filter substrate and a liquid crystal panel having liquid crystal injected into a space between the thin film transistor substrate and the color filter substrate. Generally, the liquid crystal panel is a non light-emitting device. Thus a backlight unit is disposed behind the thin film transistor substrate for supplying light. A transmittance of light emitted from the backlight unit is adjusted according to an arrangement of the liquid crystal. The liquid crystal panel and the backlight unit can be disposed in a chassis.

The backlight unit can be classified as an edge type backlight unit and a direct type backlight unit according to a location of a light source. In the edge type backlight unit, the light source is provided at a side surface of a light guide plate. The edge type backlight unit can be used in a small sized liquid crystal display such as, for example, a laptop computer screen and a desktop computer screen. The edge type backlight unit can be used to reduce the thickness of the LCD. The edge type backlight unit exhibits increased uniformity of light and durability of the unit.

A point light source such as, for example, a light emitting diode can be used as the light source of the edge type backlight unit. The point light sources can be disposed, for example, along a side surface of the light guide plate at regular intervals.

To obtain white light using light emitting diodes as the light source, a blue light emitting diode, a green light emitting diode and a red light emitting diode should be used concurrently. However, this process can be difficult to implement. Another approach to obtain white light is using a white emitting diode. However, manufacturing the backlight unit comprising a white emitting diode is expensive.

### SUMMARY OF THE INVENTION

Embodiments of the present invention provide a liquid crystal display comprising a backlight assembly which can obtain white light through a color conversion of light.

According to an embodiment of the present invention, a backlight assembly includes a light guiding plate having a plurality of color converters formed on at least one surface thereof, and a light source part for supplying light to the light guiding plate.

The light source part may emit blue light.

The color converter converts the blue light emitted from the light source part into white light.

The color converter may comprise a fluorescent material.

The fluorescent material may comprise at least one of Y₃Al₅O₁₂:Ce³⁺, SrGa₂S₄:Eu²⁺, or CaS:Eu²⁺.

The light source part can be disposed along at least one side of the light guiding plate. As the space between the color converters and the light source part increases, the spaces between the color converters decreases.

The color converters may comprise at least one of a disk pattern, a hemisphere dotted pattern, a stripe pattern which is perpendicular to the light source part, a stripe pattern which is parallel with the light source part and a lattice pattern.

The light guide plate may have a groove pattern with V shaped grooves formed on the surface thereof, the color converters being formed between the V shaped grooves.

The color converter may further comprise a diffuser.

The color converter may further comprise a binder.

The light source part may comprise one of a light emitting diode or a cold cathode fluorescent lamp.

According to an embodiment of the present invention, a liquid crystal display includes a liquid crystal display panel, a light guiding plate disposed behind the liquid crystal display panel, the light guiding plate having a reflecting surface on which a plurality of color converters are formed, and a light source part for supplying light to the light guiding plate.

The liquid crystal display device may further comprise a reflective plate corresponding to the reflecting surface of the light guide plate.

The light source part can be disposed along at least one side of the light guiding plate.

As the space between the color converters and the light source part increases, the spaces between the color converters decreases. The light source part may emit blue light and the color converter converts the blue light emitted from the light source part into white light.

The color converter may comprise a fluorescent material.

The fluorescent material may comprise at least one of Y₃Al₅O₁₂:Ce³⁺, SrGa₂S₄:Eu²⁺, or CaS:Eu²⁺.

The color converters may comprise at least one of a disc pattern, a hemisphere pattern, a stripe pattern which is perpendicular to an extension direction of the light source part, a stripe pattern which is parallel with an extension direction of the light source part and a lattice shaped pattern.

The light guide plate may have a plurality of patterns with the V shape in section formed on the surface thereof on which the color converter is formed.

The color converter may further comprise a diffuser.

The color converter may further comprise a binder.

The light source part may comprise one of a light emitting diode or a cold cathode fluorescent lamp.

### BRIEF DESCRIPTION OF THE DRAWINGS

Exemplary embodiments of the present invention can be understood in more detail from the following description taken in conjunction with the accompany drawings, in which:

FIG. 1 is an exploded perspective view of a liquid crystal display according to an embodiment of the present invention;

FIG. 2 is a sectional view of a liquid crystal display according to an embodiment of the present invention;

FIG. 3 is an exploded perspective view of a backlight assembly according to an embodiment of the present invention;

FIGS. 4A-4D are drawings illustrating a color conversion of light on a liquid crystal display according to an embodiment of the present invention;

FIG. 5 is an exploded perspective view of a backlight assembly according to an embodiment of the present invention;

FIG. 6 is an exploded perspective view of a backlight assembly according to an embodiment of the present invention;

FIG. 7 is an exploded perspective view of a backlight assembly according to an embodiment of the present invention;

FIG. 8 is an exploded perspective view of a backlight assembly according to an embodiment of the present invention; and

FIG. 9 is an exploded perspective view of a backlight assembly according to an embodiment of the present invention.

### DETAILED DESCRIPTION OF EXEMPLARY EMBODIMENTS OF THE INVENTION

Exemplary embodiments of the present invention are more fully described below with reference to the accompanying drawings. The present invention may be embodied in many different forms and should not be construed as being limited to the embodiments set forth herein.

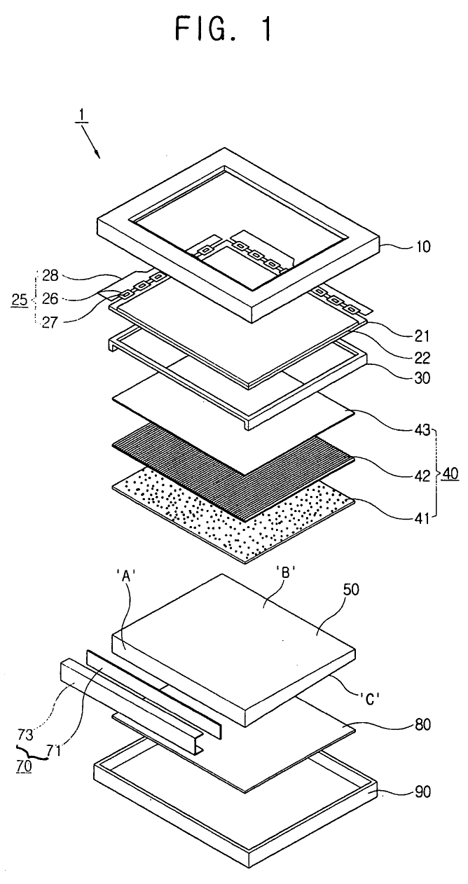

A liquid crystal display 1 according to an embodiment of the present invention is described with reference to FIG. 1 to FIG. 3.

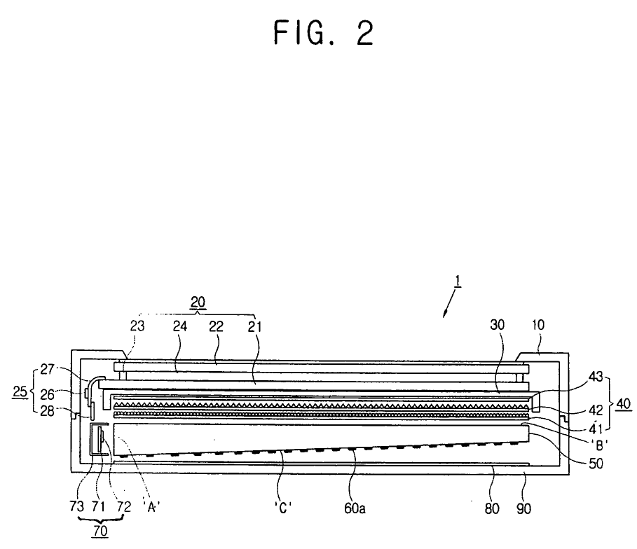

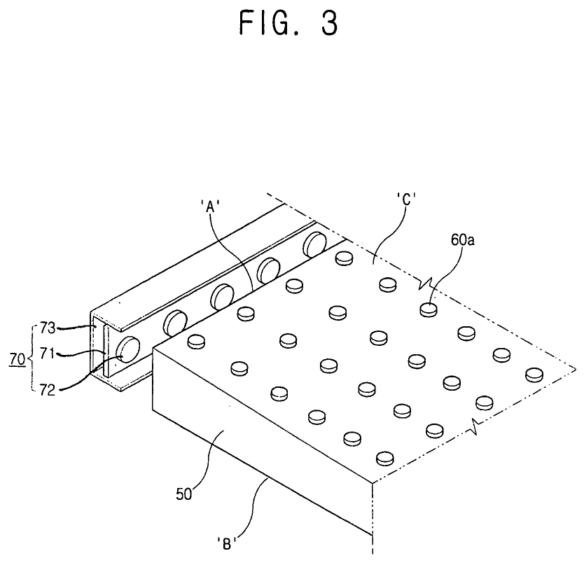

FIG. 1 is an exploded perspective view of a liquid crystal display 1 according to an embodiment of the present invention. FIG. 2 is a sectional view of the liquid crystal display 1 according to an embodiment of the present invention. FIG. 3 is an exploded perspective view of a backlight assembly according to an embodiment of the present invention.

Referring to FIG. 1 to FIG. 3, the liquid crystal display 1 comprises a liquid crystal display panel 20 and a backlight assembly. The backlight assembly comprises an optical member 40 disposed behind or under the liquid crystal display panel 20, a light source part 70 and a light guide plate 50 disposed behind the optical member 40. The light guide plate 50 guides light emitted from the light source part 70 to the optical member 40. The light source part 70 is disposed along one side surface of the light guide plate 50. A reflective plate 80 is located under the light guide plate 50. The liquid crystal display panel 20, the optical member 40, the light guide plate 50, the light source part 70 and the reflective plate 80 are disposed in a space formed by an upper chassis 10 and a bottom chassis 90.

The liquid crystal display panel 20 comprises a thin film transistor substrate 21, a color filter substrate 22, a sealant 23, and a liquid crystal layer 24. A thin film transistor is formed on the thin film transistor substrate 21. The color filter substrate 22 is formed opposite the thin film transistor substrate 21. The sealant 23 adheres both substrates 21 and 22 to each other to form a cell gap. The liquid crystal layer 24 is placed in a space formed by both substrates 21 and 22 and the sealant 23. . For a non light-emitting type LCD, the liquid crystal panel 20 receives light from the light source part 70.

A driving part 25 is provided at one side of the thin film transistor substrate 21 for supplying a driving signal. The driving part 25 comprises a flexible printed circuit (FPC) board 26, a driving chip 27 mounted to the FPC board 26 and a printed circuit board (PCB) 28 connected to the FPC board 26. The driving part 25 can be, for example, a chip on film (COF) type, a tape carrier package (TCP) type, or a chip on glass (COG) type. The driving part 25 can be formed on the thin film transistor substrate 21 during a process of forming a wire according to an embodiment of the present invention.

The optical member 40 located behind the liquid crystal display panel 20 may comprise a diffusion sheet 41, a prism sheet 42 and a protective sheet 43.

The diffusion sheet 41 comprises a base plate and a coating layer. The coating layer includes beads formed on the base plate. The diffusion sheet 41 is used to uniformly diffuse light supplied from the light guide plate 50 to a front surface of the liquid crystal display panel 20.

A plurality of triangular sectioned prisms can be formed on an upper surface of the prism sheet 42. The prism sheet 42 concentrates light diffused through the diffusion sheet 41 in a direction which is perpendicular to a plane of the liquid crystal display panel 20. If two sheets of the prism sheets 42 are used, micro prisms formed on each prism sheet 42 are formed at a predetermined angle. Most of the light passing through prism sheet 42 can be perpendicular to the LCD panel 20. Thus the uniform brightness distribution can be achieved.

The protective sheet 43 placed on the prism sheet 42 protects the prism sheet 42 from scratches.

The light guide plate 50 is placed under the diffusion sheet 41. The light guide plate 50 may have a rectangular plate shape and may comprise polymethylmethacrylate (PMMA) which is acrylic resin. The light guide plate 50 changes light emitted from the light source part 70 disposed at the side surface of the light guide plate 50 into surface light. The light guide plate 50 guides the surface light to the diffusion sheet 41. That is, the light guide plate 50 converts horizontal light into vertical light with respect to the liquid crystal display panel 20. A side surface of the light guide plate 50 corresponding to the light source part 70 can be used as a light incident surface A. An upper surface thereof corresponding to the liquid crystal display panel 20 can be used as a light radiating surface B. A lower surface of the light guide plate 50 corresponding to the reflective plate 80 can be used as a reflecting surface C. Light transmitted into the light guide plate 50 through the incident surface A is radiated through the entire light radiating surface B.

Color converters 60a comprising, for example, a fluorescent material can be formed on the reflecting surface C of the light guide plate 50. Each color converter 60a can be formed in a dotted pattern. The fluorescent material may comprise at least one of Y₃Al₅O₁₂:Ce³⁺, SrGa₂S₄:Eu²⁺, and CaS:Eu²⁺. A mixture of two of Y₃Al₅O₁₂:Ce³⁺, SrGa₂S₄:Eu²⁺, and CaS:Eu²⁺ can be used as the fluorescent material according to an embodiment of the present invention. The color converter 60a comprising the fluorescent material may convert blue light emitted from the light source part 70 into white light.

The light guide plate 50 can be used as a wave guide which converts light emitted from the light source part 70 into surface light which is perpendicular to the liquid crystal display panel 20 and radiates the surface light. Uniform surface light may not be obtained according to a relation between the light guide plate 50 and the light source part 70. In an embodiment, various shaped patterns of color converters 60a may be formed on the reflecting surface C of the light guide plate 50. In an embodiment, the reflecting surface C of the light guide plate 50 may be patterned. In an embodiment, color converters 60a can be formed on the reflecting surface C, and the reflecting surface C of the light guide plate 50 may be patterned.

In an embodiment of the present invention, the color converters 60a comprising a fluorescent material are formed on the reflecting surface C of the light guide plate 50 in the disk shaped pattern, so that uniform surface light can be obtained and blue light can be converted into white light. The plurality of color converters 60a are provided on the reflecting surface C of the light guide plate 50. The color converters 60a can have the same shapes and can be disposed at predetermined intervals. The color converters 60a can be formed on the entire reflecting surface C, and each color converter 60a can be protruded toward the reflective plate 80. For radiating light reflected from the reflecting surface C of the light guide plate 50 perpendicularly to the liquid crystal display panel 20 as surface light, a gap between two adjacent color converters 60a may decrease when a space between the color converter 60a and the light source part 70 increases.

The color converter 60a may further comprise a diffuser which enables light to be diffused uniformly. The color converter 60a may further comprise a binder for mixing, for example, a fluorescent material and the diffuser uniformly and for maintaining a desired viscosity.

The light source part 70 is disposed along at least one side of the light guide plate 50. The light source part 70 comprises a light emitting diode circuit substrate 71, a light emitting diode 72 mounted on the light emitting diode circuit substrate 71 and a reflector 73 surrounding the light emitting diode circuit substrate 71.

In an embodiment, the light emitting diode circuit substrate 71 has a bar-shape and is disposed toward the light radiating surface A of the light guide plate 50. The light emitting diode circuit substrate 71 can comprise aluminum which has an excellent heat transmission property so as to reduce heat generated in the LED 72.

In an embodiment, a plurality of light emitting diodes 72 can be disposed on the light emitting diode circuit substrate 71 at a regular interval. The light source part 70 may supply blue light. For supplying the blue light, in an embodiment, only blue light emitting diodes are used as the light emitting diodes 72. Alternatively, blue light emitting diodes and other colored light emitting diodes can be used for supplying the blue light. When the blue light emitting diodes and other colored light emitting diodes are used to supply the blue light, more blue light diodes are used as compared to other colored light emitting diodes.

The reflector 73 can be used to reflect light generated in the light emitting diodes 72 to the light guide plate 50. The reflector 73 may comprise, for example, aluminum having an excellent reflectance. A surface of the reflector corresponding to the light emitting diodes 72 may be coated with, for example, silver.

The reflective plate 80 located behind the light guide plate 50 is used to reflect light leaked from the light guide plate 50 and return the light to light guide plate 50. The reflective plate 80 may comprise, for example, polyethylen terephthalate, or polycarbonate.

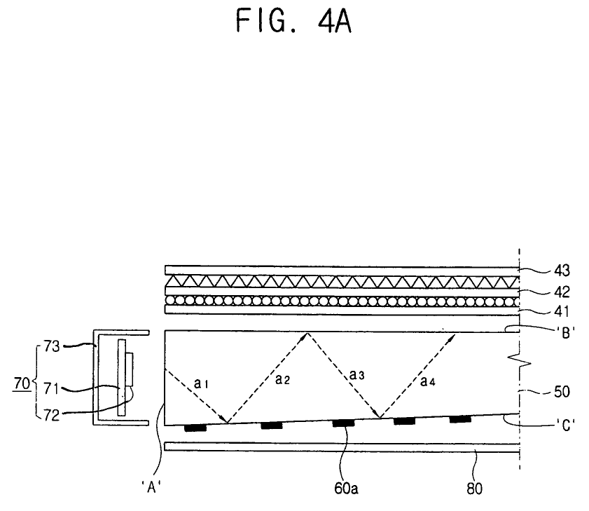

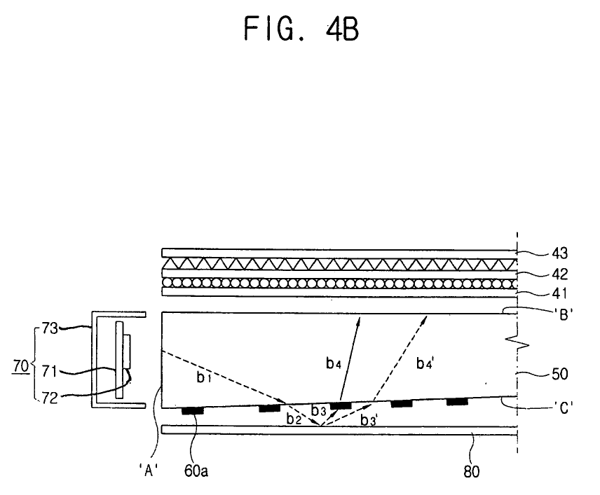

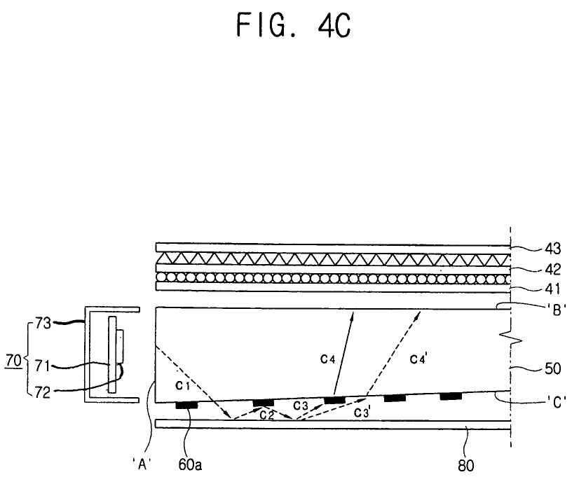

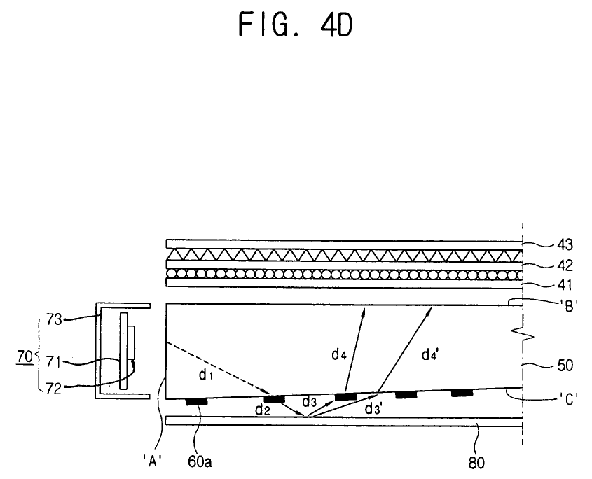

In the liquid crystal display device 1 according to an embodiment of the present invention, the color converters 60a comprising a fluorescent material are formed on the reflecting surface of the light guide plate 50 so that the color converters 60a can convert blue light emitted from the light source part 70 into white light. A method for converting blue light into white light is described with reference to light paths shown in FIG. 4A to FIG. 4D.

Blue light emitted from the light source part 70 passes along a light path in the light guide plate 50 due to a specular reflection (FIG. 4A). Blue light emitted from the light source part 70 does not pass through the color converters 60a (FIG. 4B). Blue light emitted from the light source part 70 leaks from the light guide plate 50, and is dispersed on or reflected from surfaces of the patterns (FIG. 4C). Blue light emitted from the light source part 70 passes through the color converters 60a (FIG. 4D).

Referring to FIG. 4A, after blue light emitted from the light source part 70 transmits into the light guide plate 50 through an incident surface A of the light guide plate 50 (a₁), blue light is reflected specularly (a₂ to a₄), and thus the blue light does not pass through the color converters 60a. In this embodiment, blue light is not converted into white light. In FIGS. 4B through 4D, the solid lines indicate the light paths along which white light converted from blue light passes, and the dashed lines indicate the light paths along which blue light passes.

Referring to FIG. 4B, when blue light does not pass through the color converter 60a after blue light is transmitted into the light guide plate 50 from the light source part 70 (b₁), blue light is leaked (b₂) from the light guide plate 50 and reflected (b₃, b₃′) from the reflective plate 80 and transmitted (b₄, b₄′) again into the light guide plate 50. Light can pass through two paths. In a first path, blue light passes through the color converter 60a and then is transmitted again into the light guide plate 50 along the path b₄. In a second path, blue light does not pass through the color converter 60a and is transmitted again into the light guide plate 50 along the path b₄′. The blue light can be converted into white light on the path b₄. The blue light is not converted on the path b₄′. Once the blue light which is not converted passes again through the color converter 60a, the blue light may be converted into white light.

Referring to FIG. 4C, blue light leaked (c₂) from the light guide plate 50 is dispersed on or reflected from a surface of the color converter 60a after blue light is transmitted (c₁) into the light guide plate 50 from the light source part 70. The blue light leaked (c₂) from the light guide plate 50 is reflected (C₃, C₃′) from the reflective plate 80 and is transmitted (C₄, C₄′) again into the light guide plate 50. Light can pass through two paths. In a first path, blue light can pass through the color converter 60a and then is transmitted again into the light guide plate 50 along the path C₄. In a second path, blue light does not pass through the color converter 60a and is transmitted again into the light guide plate 50 along the path C₄′. Blue light can be converted into white light on the path C₄. Blue light is not converted on the path C₄′. Once the light which is not converted passes again through the color converter 60a, blue light may be converted into white light.

Referring to FIG. 4D, blue light passes through the color converter 60a after blue light is transmitted (d₁) into the light guide plate 50 from the light source part 70. Since blue light reaches the reflective plate 80 after blue light passes through the color converter 60a comprising a fluorescent material, blue light emitted from the light source part 70 is converted into white light on paths d₄, d₄′. Light passed (d₂) through the color converter 60a is reflected (d₃, d₃′) from the reflective plate 80 and is transmitted again into the light guide plate 50. Accordingly, unlike the embodiments described in connection with FIG. 4B and FIG. 4C, white light may be obtained independent of whether light passes through the color converter 60a or not when light is transmitted (d₄, d₄′) again into the light guide plate 50.

Although blue light passes along the various paths as above, blue light may not be converted into white light and may be transmitted into the light guide panel 50. For transmitting light along a path passing through the color converter 60a, the user may adjust a component ratio of fluorescent material, diffuser and binder contained in the color converter 60a. Alternatively, the user may adjust an arrangement of the color converter 60a.

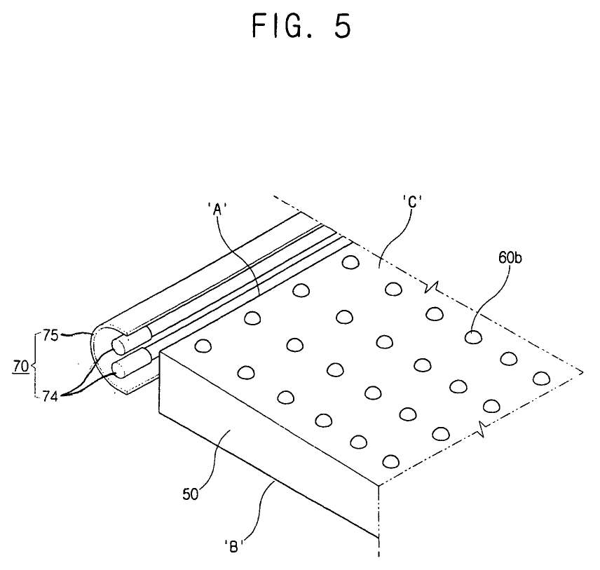

A backlight assembly according to an embodiment of the present invention is described with reference to FIG. 5.

FIG. 5 is an exploded perspective view of a backlight assembly according to an embodiment of the present invention. Referring to FIG.5, the color converters 60b are formed on the reflecting surface C of the light guide plate 50, each of which is formed in a hemisphere shape. Each color converter 60b is curved convexly toward the reflective plate 80.

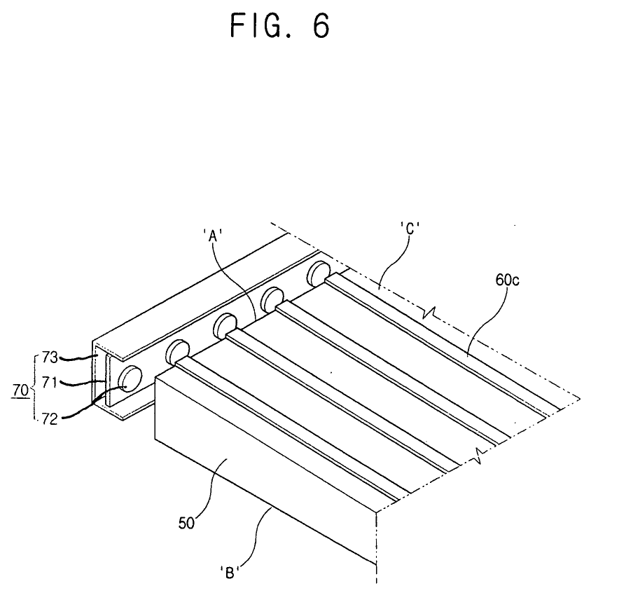

A backlight assembly according to an embodiment of the present invention is described with reference to FIG. 6.

FIG. 6 is an exploded perspective view of a backlight assembly according to an embodiment of the present invention. Referring to FIG. 6, the color converters 60c are formed on the reflecting surface C of the light guide plate 50, each of which is formed in a stripe shape which is perpendicular to the light source part 70. Each color converter 60c is protruded toward the reflective plate 80.

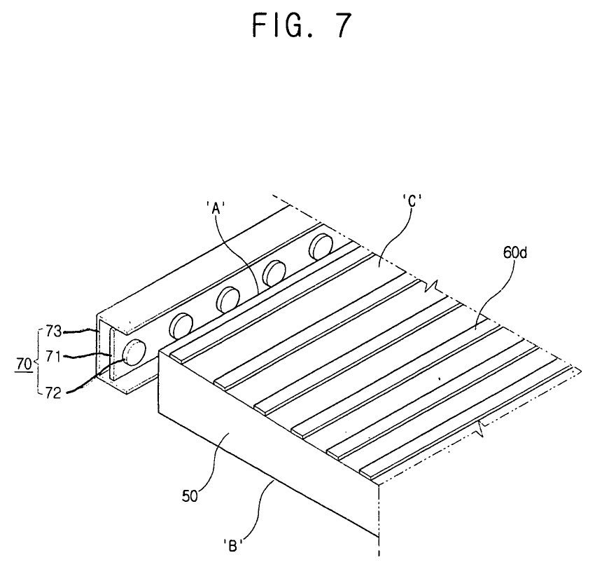

A backlight assembly according to an embodiment of the present invention is described with reference to FIG. 7.

FIG. 7 is an exploded perspective view of a backlight assembly according to an embodiment of the present invention. Referring to FIG. 7, the color converters 60d are formed on the reflecting surface C of the light guide plate 50, each of which is formed in a stripe shape which is parallel with the light source part 70. Each color converter 60d is protruded toward the reflective plate 80.

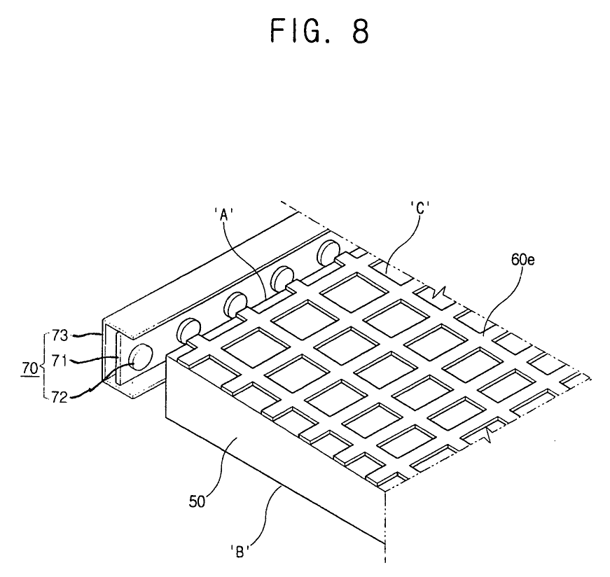

A backlight assembly according to an embodiment of the present invention is described with reference to FIG. 8.

FIG. 8 is an exploded perspective view of a backlight assembly according to an embodiment of the present invention. Referring to FIG. 8, the color converter 60e is formed on the reflecting surface C of the light guide plate 50 in a lattice shape. The color converter 60e comprises first stripes which are perpendicular to the light source part 70 and second stripes which are parallel with the light source part 70. The color converter 60d is protruded toward the reflective plate 80.

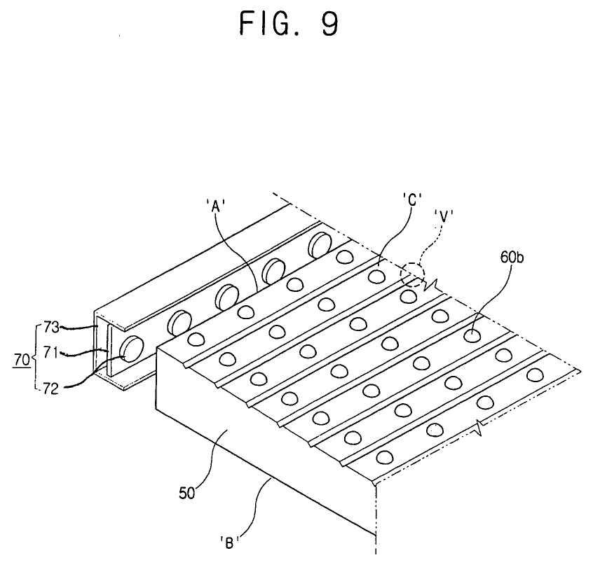

A backlight assembly according to an embodiment of the present invention is described with reference to FIG. 9.

FIG. 9 is an exploded perspective view of a backlight assembly according to an embodiment of the present invention. Referring to FIG. 9, V-shaped grooves V are formed on the reflecting surface C of the light guide plate 50. Although each groove V is disposed parallel with the light source part 70, each groove V may be disposed perpendicularly to the light source part 70. Each groove V is formed concavely with respect to the reflective plate 80. As the grooves V become farther from the light source part 70, the spaces between the grooves V become smaller. . As the color converters 60b become farther from the light source part 70, the spaces between the color converters 60b become smaller. The color converters 60b are formed on adjacent flat areas on which the grooves V are not formed.

According to exemplary embodiments of the present invention, to obtain uniform surface light according to a positional relation between the color converter and the light source part 70, as the distance between the color converters and the light source part 70 become larger, the spaces between the color converters become smaller. In addition, as the color converters are farther from the light source part 70, a size of the color converters becomes larger. In an embodiment, the color converters formed in various shaped patterns may be arranged concurrently on the reflecting surface of the light guide plate.

The light source parts may be provided in a pair at opposite sides of the light guide panel. In an embodiment, a flat plate typed light guide panel can be provided.

According to an embodiment of the present invention, as shown in FIG. 5, a cold cathode fluorescent lamp 74 in which fluorescent material for emitting blue light is coated can be used to emit the blue light. A reflector 75 is used to reflect light emitted from the cold cathode fluorescent lamp 74 to the light guide plate 50. The reflector 75 may comprise, for example, aluminum. A surface of the reflector corresponding to the cold cathode fluorescent lamp 74 can be coated with silver.

According to exemplary embodiments of the present invention, the back light assembly which may obtain white light through a color conversion of light and the liquid crystal display device comprising the same are provided.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A backlight assembly, comprising:
a light guiding plate having a plurality of color converters formed on at least one surface thereof; and
a light source part for supplying light to the light guiding plate.

2. The backlight assembly according to claim 1, wherein the light source part emits blue light.

3. The backlight assembly according to claim 2, wherein the color converter converts the blue light emitted from the light source part into white light.

4. The backlight assembly according to claim 3, wherein the color converter comprises a fluorescent material.

5. The backlight assembly according to claim 4, wherein the fluorescent material comprises at least one of Y₃Al₅O₁₂:Ce³⁺, SrGa₂S₄:Eu²⁺, or CaS:Eu²⁺.

6. The backlight assembly according to claim 4, wherein the light source part is disposed along at least one side of the light guiding plate.

7. The backlight assembly according to claim 4, wherein as the space between the color converters and the light source part increases, the spaces between the color converters decreases.

8. The backlight assembly according to claim 1, wherein the color converters comprise at least one of a disk pattern, a hemisphere dotted pattern, a stripe pattern which is perpendicular to the light source part, a stripe pattern which is parallel with the light source part and a lattice pattern.

9. The backlight assembly according to claim 1, wherein the light guide plate has a groove pattern with V shaped grooves formed on the surface thereof, the color converters being formed between the V shaped grooves.

10. The backlight assembly according to claim 4, wherein the color converter further comprises a diffuser.

11. The backlight assembly according to claim 4, wherein the color converter further comprises a binder.

12. The backlight assembly according to claim 6, wherein the light source part comprises one of a light emitting diode or a cold cathode fluorescent lamp.

13. The backlight assembly according to claim 1, further comprising an optical member including a protective sheet, a prism sheet, and a diffusion sheet.

14. A liquid crystal display, comprising
a liquid crystal display panel;
a light guiding plate disposed behind the liquid crystal display panel, the light guiding plate having a reflecting surface comprising a plurality of color converters; and
a light source part for supplying light to the light guiding plate.

15. The liquid crystal display device according to claim 14, further comprising a reflective plate disposed behind the light guiding plate, the reflective plate corresponding to the reflecting surface of the light guiding plate.

16. The liquid crystal display device according to claim 14, wherein the light source part is disposed along at least one side of the light guiding plate.

17. The liquid crystal display device according to claim 14, wherein as the space between the color converters and the light source part increases, the spaces between the color converters decreases.

18. The liquid crystal display device according to claim 14, wherein the light source part emits blue light and the color converters convert the blue light emitted from the light source part into white light.

19. The liquid crystal display device according to claim 18, wherein the color converters comprise a fluorescent material.

20. The liquid crystal display device according to claim 19, wherein the fluorescent material comprises at least one of Y₃Al₅O₁₂:Ce³⁺, SrGa₂S₄:Eu²⁺, or CaS:Eu ²⁺.

21. The liquid crystal display device according to claim 19, wherein the color converters comprise at least one of a disc pattern, a hemisphere pattern, a stripe pattern which is perpendicular to an extension direction of the light source part, a stripe pattern which is parallel with an extension direction of the light source part, and a lattice pattern.

22. The liquid crystal display device according to claim 19, wherein the light guide plate has a plurality of patterns with V shaped grooves formed on the surface thereof, the color converter being formed between the V shaped grooves.

23. The liquid crystal display device according to claim 19, wherein the color converters further comprise a diffuser.

24. The liquid crystal display device according to claim 19, wherein the color converters further comprise a binder.

25. The liquid crystal display device according to claim 16, wherein the light source part comprises one of a light emitting diode or a cold cathode fluorescent lamp.

26. The liquid crystal display device according to claim 14, further comprising an optical member including a protective sheet, a prism sheet, and a diffusion sheet.
